(19) United States
(12) Patent Application Publication
(10) Pub. No.: US 2024/0413356 A1
(43) Pub. Date: Dec. 12, 2024

(54) AN ELECTROCHEMICAL CELL WITH A CONNECTIVE NANOSTRUCTURE

(71) Applicant: Smoltek AB, GÖTEBORG (SE)

(72) Inventors: Fabian Wenger, GÖTEBORG (SE); Qi Li, GÖTEBORG (SE)

(21) Appl. No.: 18/695,056

(22) PCT Filed: Oct. 5, 2022
(86) PCT No.: PCT/EP2022/077721

§ 371 Date: Mar. 25, 2024

(30) Foreign Application Priority Data
Oct. 19, 2021 (SE) 2130282-3

(51) Int. Cl. H01M 8/0228; C25B 9/23; C25B 11/032; C25B 11/061; C25B 11/065; H01G 11/68; H01G 11/70; H01G 11/84; H01M 4/13; H01M 8/0206; H01M 8/0213; H01M 8/0232; H01M 8/0234; H01M 8/0245

(52) U.S. Cl. CPC H01M 8/0228; C25B 9/23; C25B 11/032; C25B 11/061; C25B 11/065; H01M 4/13; H01M 8/0206; H01M 8/0213; H01M 8/0232; H01M 8/0234; H01M 8/0245; H01G 11/68; H01G 11/70; H01G 11/84

(57) ABSTRACT

An electrochemical cell comprising a layered structure, the layered structure comprising at least a first layer and a second layer. The first layer and the second layer are arranged adjacent to each other and form a first interface, wherein the first interface comprises a first plurality of elongated nanostructures connected to a first surface of the first layer facing the second layer, and a second plurality of elongated nanostructures connected to a second surface of the second layer facing the first layer. The first plurality of elongated nanostructures and the second plurality of elongated nanostructures are mechanically entangled.

### TECHNICAL FIELD

The present disclosure relates to electrochemical cells such as fuel cells, electrolyzers, and batteries, and particularly to means for connecting components of the electrochemical cell.

### BACKGROUND

Electrochemical cells such as batteries, fuel cells, and electrolyzers are finding widespread application in modern energy systems. The production of hydrogen gas through the electrolysis of water is a promising technology both for replacing the production of hydrogen gas from fossil fuels and as a means of converting excess electrical energy from intermittent energy sources such as solar and wind power to chemical energy for storage. Fuel cells, meanwhile, are an attractive technology for the conversion of chemical energy into electrical energy, partly due to their high efficiency compared to e.g., internal combustion engines and partly due to that they can easily use environmentally friendly fuels such as sustainably produced hydrogen gas. Also, batteries are finding increasing use in e.g. electrical vehicles.

However, existing electrochemical cells suffer from problems relating to high contact resistance between components of the cell.

WO 2019/186047 A1 discloses a component for an electrochemical cell with a reduced contact resistance. Still, there is a need for electrochemical cells with lowered contact resistance.

### SUMMARY

It is an object of the present disclosure to provide improved electrochemical cells, which, i.a., offer lowered contact resistance between components.

This object is at least in part obtained by an electrochemical cell comprising a layered structure. The layered structure comprises at least a first layer and a second layer, the first layer and the second layer being arranged adjacent to each other and forming a first interface. The first interface comprises a first plurality of elongated nanostructures connected to a first surface of the first layer facing the second layer.

The interface also comprises a second plurality of elongated nanostructures connected to a second surface of the second layer facing the first layer. The first plurality of elongated nanostructures and the second plurality of elongated nanostructures are mechanically entangled.

The mechanical entanglement of the first and second plurality of elongated nanostructures can also be described as the first and second plurality of elongated nanostructures forming an interlocking structure. Advantageously, this forms a mechanical bond between the first and second layers, leading to a better mechanical contact between the layers and a reduction of the electrical contact resistance between the layers. In particular, if the first and/or second layer has an uneven or porous surface, the interlocking structure formed by the first and second plurality of elongated nanostructures may considerably increase the area of contact between the two layers compared to if the two bare surfaces were placed in contact, thereby lowering the electrical contact resistance.

An additional advantage may occur if the first and/or second layer changes in shape and/or volume during operation of the electrochemical cell. If the first and second plurality of elongated nanostructures are arranged to maintain mechanical entanglement throughout the changes in volume and/or shape, both the electrical contact resistance and the risk of delamination of the layers can be reduced due to the disclosed mechanical entanglement.

According to some aspects, at least some of the elongated nanostructures comprised in the first plurality of elongated nanostructures can be oriented in parallel to each other and extend along a direction perpendicular to the plane of extension of the first layer. Likewise, at least some of the elongated nanostructures comprised in the second plurality of elongated nanostructures may be oriented in parallel to each other and extend along a direction perpendicular to the plane of extension of the second layer.

If at least some of the elongated nanostructures in the first and/or second plurality of elongated nanostructures extend along a direction perpendicular to the plane of extension of the respective first or second layer, i.e. the elongated nanostructures are perpendicularly oriented, this facilitates the formation of mechanical entanglement. The perpendicularly oriented nanostructures comprised in the first plurality of elongated nanostructures may for example extend into the spaces between elongated nanostructures comprised in the second plurality of elongated nanostructures, and vice versa. Additionally, the extent of the elongated nanostructures along the direction perpendicular to the plane of extension can be adjusted to compensate for the surface of the first and/or second layer being uneven.

According to other aspects, at least some of the elongated nanostructures comprised in the first plurality of elongated nanostructures may extend along a direction parallel to the plane of extension of the first layer. Likewise, at least some of the elongated nanostructures comprised in the second plurality of elongated nanostructures may extend along a direction parallel to the plane of extension of the second layer.

Advantageously, if some of the elongated nanostructures of the first and/or second plurality of elongated nanostructures extend parallel to the plane of extension of the respective first and second layer, this may facilitate the formation of mechanical entanglement with perpendicularly oriented elongated nanostructures connected to the other layer by forming spaces into which the perpendicularly oriented nanostructures can extend.

The first and/or second plurality of elongated nanostructures may comprise elongated carbon nanostructures. Advantageously, carbon nanostructures display good electrical conductivity and adequate chemical stability for use in many electrochemical cells. In particular, the elongated carbon nanostructures may be carbon allotropes such as any of carbon nanofibers, carbon nanowires, carbon nanotubes, and carbon nanowalls. The properties, such as density and shape, of carbon nanofibers, nanowires, nanowalls, and nanotubes can easily be adjusted by altering the conditions under which the nanofibers, nanowires, nanowalls, and nanotubes are produced. Carbon nanofibers, nanowalls, and nanowires are also mechanically rigid, making it easier to maintain their orientation relative to the first and/or second layer during assembly of the electrochemical cell.

The first and/or second plurality of elongated nanostructures may also comprise nanostructures comprising any of a metal, an alloy, a semiconductor, and a metal oxide. Such nanostructures display high electrical conductivity and good mechanical stability, which is an advantage.

Due to the harsh chemical environment in electrochemical cells, resulting e.g. from high or low pH and high electrical potentials, materials forming components of the electrochemical cell may be at risk of corrosion. Therefore, the first and/or second plurality of elongated nanostructures may comprise a protective coating arranged to increase a resistance to corrosion. The protective coating may comprise any of titanium, gold, platinum, or a platinum-group metal.

According to aspects, the electrochemical cell may be a fuel cell comprising a layered structure. In that case, the layered structure comprises a first conductive element and a second conductive element as well as a first porous transport layer and a second porous transport layer arranged adjacent to the respective first and second conductive element. The layered structure further comprises a first electrocatalyst layer and a second electrocatalyst layer arranged adjacent to the respective first and second porous transport layer, and an ion exchange membrane arranged between the first and second electrocatalyst layer.

Any pair of adjacent layers in the layered structure comprised in the fuel cell may form an interface comprising a first and second plurality of elongated nanostructures as previously described. Advantageously, this can reduce the electrical contact resistance between adjacent layers, along with other advantages as described above.

According to one example, the first layer many be any of the first and second conductive elements and the second layer may then be the respective first or second porous transport layer. According to another example, the first layer may be any of the first and second porous transport layers and the second layer may then be the respective first or second electrocatalyst layer.

According to other aspects, the electrochemical cell may be an electrolyzer comprising a layered structure. In the electrolyzer, the layered structure comprises a first conductive element and a second conductive element. The layered structure further comprises a first porous transport layer and a second porous transport layer arranged adjacent to the respective first and second conductive element, as well as a first electrocatalyst layer and a second electrocatalyst layer arranged adjacent to the respective first and second porous transport layer. The layered structure also comprises an ion exchange membrane arranged between the first and second electrocatalyst layer.

Any pair of adjacent layers in the layered structure comprised in the electrolyzer may form an interface comprising a first and second plurality of elongated nanostructures as previously described. Advantageously, this can reduce the electrical contact resistance between adjacent layers, along with other advantages as described above.

According to one example, the first layer may be any of the first and second conductive elements and the second layer may be the respective first or second porous transport layer. According to another example, the first layer may be any of the first and second porous transport layers and the second layer may be the respective first or second electrocatalyst layer.

The electrochemical cell may also be a battery comprising at least one layered structure. In the battery, the layered structure may comprise a current collector and an active layer, where the active layer comprises an electrode material.

According to one example, the battery comprises two layered structures, each comprising a current collector and an active layer, separated by a liquid electrolyte. According to another example, the battery comprises one layered structure comprising a first current collector, a first active layer, an electrolyte layer comprising a solid, semisolid or gel-like electrolyte, a second active layer, and a second current collector.

Any pair of adjacent layers in the layered structure comprised in the battery may form an interface comprising a first and second plurality of elongated nanostructures as previously described. Advantageously, this can reduce the electrical contact resistance between adjacent layers, along with other advantages as described above. Additionally, active layers in battery cells may undergo changes in volume during charging and discharging. The first and second plurality of elongated nanostructures may be arranged to maintain mechanical entanglement throughout the charging and discharging cycle, which is an advantage. Thus the first layer may be the current collector, and the second layer may be the active layer in the at least one layered structure.

There is also herein disclosed a method for producing a layered structure for an electrochemical cell, where the electrochemical cell comprises a layered structure. The layered structure in turn comprises at least a first layer and a second layer. The method comprises generating a first plurality of elongated nanostructures, where the elongated nanostructures are connected to a first surface of the first layer. The method also comprises generating a second plurality of elongated nanostructures that are connected to a second surface of the second layer, and arranging the first layer adjacent to the second layer to form a first interface, so that the first surface of the first layer faces the second surface of the second layer. This enables the first plurality of elongated nanostructures and the second plurality of elongated nanostructures to connect the first and second layers through mechanical entanglement.

The mechanical entanglement of the first and second plurality of elongated nanostructures can also be described as the first and second plurality of elongated nanostructures forming an interlocking structure. Advantageously, this forms a mechanical bond between the first and second layers, leading to a better mechanical contact between the layers and a reduction of the electrical contact resistance between the layers. In particular, if the first and/or second layer has an uneven or porous surface, the interlocking structure formed by the first and second plurality of elongated nanostructures may considerably increase the area of contact between the two layers compared to if the two bare surfaces were placed in contact.

Generating the first and/or second plurality of nanostructures may comprise growing the elongated nanostructures on a substrate. Advantageously, growing the elongated nanostructures on a substrate makes it possible to tailor the properties and shape of the nanostructures by adjusting the conditions under which the nanostructures are grown, e.g., to improve the mechanical and electrical contact between the first and second layer. For example, the thickness of the elongated nanostructures may be selected to improve structural stability.

Growing the elongated nanostructures on a substrate may comprise depositing a growth catalyst layer on a surface of the substrate and growing the elongated nanostructures on the growth catalyst layer. The growth catalyst layer promotes growth of the elongated nanostructures. By altering the properties of the growth catalyst layer, the properties of the grown elongated nanostructures can be tuned in order to improve the functionality of the plurality of elongated nanostructures.

Depositing a growth catalyst layer may comprise depositing a uniform growth catalyst layer and introducing a pattern onto the deposited uniform growth catalyst layer. An advantage of introducing a pattern onto the deposited uniform growth catalyst layer is that it makes it possible to control the number of nanostructures per surface area on the substrate. The number of nanostructures per surface area may for example be adapted to improve electrical and mechanical contact between the first and second layer of the layered structure.

According to aspects, the method may also comprise depositing an electrically conductive layer on a surface of the substrate. Advantageously, depositing an electrically conductive layer on the surface of the substrate can produce the effect of electrically grounding the substrate. Electrically grounding the substrate may be advantageous for certain methods of growing nanostructures. If an electrically conductive layer is deposited on a surface of the substrate and a growth catalyst layer is deposited on top of the conductive layer, the conductive layer may also hinder cross-diffusion of atoms and/or molecules between the catalyst layer and the substrate.

According to other aspects, the method may also comprise coating the first and/or second plurality of nanostructures with a protective coating arranged to increase a resistance to corrosion. A protective coating may shield the first and second plurality of elongated nanostructures from the chemical environment of the electrochemical cell and prevent degradation.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 schematically illustrates a fuel cell;

FIG. 2 schematically illustrates an electrolyzer;

FIG. 3 schematically illustrates a battery;

FIG. 4 schematically illustrates a supercapacitor;

FIGS. 5A, B, C and D schematically illustrates connective nanostructures; and

FIG. 6 is a flow chart illustrating methods.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

The following description relates to electrochemical cells, with a focus on batteries, fuel cells, and electrolyzers. However, a person skilled in the art realizes that the methods and devices herein disclosed are also applicable to other types of electrochemical cells, such as e.g. flow batteries, supercapacitors, and hybrid supercapacitors.

In a fuel cell, chemical energy from a fuel is converted into electrical energy through reduction and oxidation reactions. A fuel cell comprises two electrodes, and an electrolyte that allows ions to travel between the electrodes. The electrodes are also electrically connected to an electric load, where the generated electrical energy is used.

The fuel cell electrolyte must simultaneously be a good ionic conductor, i.e., be able to transport ions, and a poor electronic conductor, i.e., hinder the transport of electrons. Fuel cell electrolytes may be liquids, such as liquid solutions of alkaline salts or molten carbonate compounds, or solids such as polymer membranes or metal oxides. Examples of polymer membrane materials are sulfonated tetrafluoroethylene, also known as Nafion, and polymers based on polysulfone or polyphenole oxide. Ion-conducting metal oxides may be e.g., doped barium zirconate, doped barium cerate, doped lanthanum gallate, or stabilized zirconia. Different electrolytes may be suitable for conducting different types of ions. For example, sulfonated tetrafluoroethylene-based membranes such as Nafion can conduct hydrogen ions, i.e., protons, and are therefore known as proton exchange membranes or PEM. Many metal oxides are suitable for conducting oxygen ions.

Preferably, the electrolyte should also hinder transport of the fuel from one electrode to the other through the electrolyte. If the electrolyte is a liquid, an additional polymer membrane may be added to hinder the fuel transport from one electrode to the other. In other cases, another material may be added to the membrane in order to hinder the fuel transport. As an example, in methanol fuel cells comprising a Nafion membrane, ruthenium may be added on one side of the membrane.

Fuel cells that use ion exchange membranes such as Nafion are often referred to as proton exchange membrane fuel cells or PEMFC, since the membrane conducts protons. In PEMFC, a hydrogen-containing fuel such as hydrogen gas is introduced at the first electrode, known as the anode, while an oxygen-containing gas is introduced at the second electrode, known as the cathode. At the anode, the hydrogen is split into protons and electrons with the aid of an electrocatalyst. This is referred to as the hydrogen oxidation reaction. The protons traverse the ion exchange membrane to the cathode, while electrons traverse the electrical connection between the anode and the cathode, where the generated electrical energy can be put to use. At the cathode, protons and electrons react with oxygen through the oxygen reduction reaction to form water. This reaction is also aided by an electrocatalyst.

A catalyst is a material or chemical compound that facilitates a chemical reaction, e.g., by lowering the amount of energy needed to start the chemical reaction. An electrocatalyst is a catalyst used in an electrochemical reaction such as the hydrogen oxidation and oxygen reduction reactions taking place in a fuel cell. Fuel cell electrocatalysts frequently comprise noble metals such as platinum, ruthenium, or palladium.

In PEMFC and other fuel cells using solid ion conductors, the anode and cathode catalysts are often arranged as electrocatalyst layers on opposite surfaces of the ion exchange membrane. For PEMFC in particular, the electrocatalyst layers often comprise an electrocatalyst material such as platinum in the form of nanoparticles, that is, particles with a diameter that is substantially smaller than one micrometer and mostly between 1 and 100 nm. The electrocatalyst layer typically also comprises a catalyst binder or support, often comprising carbon nanomaterials such as carbon nanoparticles or nanotubes, or carbon black. The electrocatalyst layer may also comprise an ionically conductive polymer, arranged to facilitate transport of hydrogen ions to the ion exchange membrane, and hydrophobic materials such as Teflon. According to aspects, a catalyst layer may be between 5 and 50 nm thick. According to other aspects, the thickness of the catalyst layer may depend on the type of catalyst used.

An ion exchange membrane with an anode electrocatalyst layer and a cathode electrocatalyst layer arranged on opposite surfaces is sometimes referred to as a membrane electrode assembly.

In order for the fuel cell to operate, ions and electrons must be able to travel from the anode-side electrocatalyst, through the ion exchange membrane and the electric load respectively and reach the cathode-side electrocatalyst. In addition, reactant gases such as hydrogen and oxygen gas must be able to reach the electrocatalyst layers, while the product, water vapor, must be continually removed from the cell. In most PEMFC, this is accomplished by arranging an electrically conductive porous material in a layer next to each catalyst layer, and a conductive element next to the layer of porous material.

The layer of porous material may for example be referred to as a porous transport layer, mass transport layer, gas diffusion layer (GDL), or just diffusion layer. Some of these terms, e.g. gas diffusion layers, are commonly used in the context of fuel cells, while some terms such as porous transport layers are more commonly used in the context of electrolyzers. However, they all refer to layers of porous material performing the function of simultaneously allowing both electron transport and mass transport of products and reactants to and from an active layer such as an electrocatalyst layer. Therefore, the different terms mentioned above will be used interchangeably in this disclosure, both in the context of fuel cells and in the context of electrolyzers.

A conductive material, element, or component is here taken to be a material, element, or component that has a high electric conductivity. A high electric conductivity could be an electric conductivity normally associated with metallic or semiconducting materials, or an electric conductivity of more than 100 Sm⁻¹.

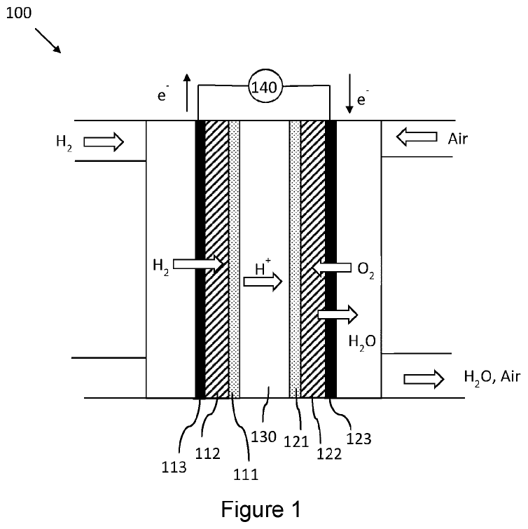

FIG. 1 shows a fuel cell 100 comprising an ion exchange membrane 130, a first electrocatalyst layer 111 and a second electrocatalyst layer 121. The first and second electrocatalyst layers 111, 121 are arranged adjacent to the ion exchange membrane on either side of the ion exchange membrane. A first PTL 112 and a second PTL 122 are arranged adjacent to the respective first and second electrocatalyst layers 111, 121 on the side of the electrocatalyst layer facing away from the ion exchange membrane 130. Adjacent to the first and second PTLs 112, 122, on the side facing away from the respective electrocatalyst layer 111, 121, there is a respective conductive element 113, 123. Each conductive element is electrically connected to the load 140.

The PTLs 112, 122, are arranged to allow reactants and products such as hydrogen gas, oxygen gas, and water to be transported through the pores of the PTL, while still maintaining electrical contact between the electrocatalyst layer and the conductive element. PTLs often comprise porous electrically conductive materials such as metal foams, porous carbon, or carbon paper. The PTLs may also provide structural support for the electrocatalyst layers 111, 121 and ion exchange membrane 130.

The conductive elements 113, 123 often comprise metallic materials such as steel and/or other electrically conductive materials such as carbon composites. The conductive elements 113, 123 are connected to the electrical load, and also separate the fuel cell from its surroundings. If the fuel cell forms part of a fuel cell stack, a conductive element may form part of the cathode side of one fuel cell and the anode side of an adjacent fuel cell, in which case it may be referred to as a bipolar plate. Other possible terms are separator plate, separator element or flow plate.

Although the preceding paragraphs focus on fuel cells comprising proton exchange membranes and using hydrogen gas as fuel, a person skilled in the art realizes that the methods and devices herein disclosed are also applicable to other types of fuel cells. Examples of such fuel cells may be fuel cells using methanol as fuel, or fuel cells comprising a different type of electrolyte such as an anion exchange membrane or a liquid electrolyte.

As previously mentioned, the present disclosure also relates to electrolyzers. Water electrolyzers use electrical energy to split water into oxygen gas and hydrogen gas. Electrolyzers may normally comprise the same or similar components as described above for fuel cells. In particular, water electrolyzers comprise an ion-conducting electrolyte and two electrodes, one of which is a cathode and the other of which is an anode. The cathode and anode are electrically connected to a power source. Proton exchange membranes such as Nafion can be used as electrolytes in electrolyzers as well as in fuel cells, as can the other abovementioned polymer membranes and solid oxide ionic conductors. Liquid electrolytes comprising an alkaline solution may also be used.

In an electrolyzer comprising a proton-conducting electrolyte such as a PEM, water is introduced at the anode side and split into oxygen and hydrogen in what is known as the oxygen evolution reaction. The oxygen forms oxygen gas while the hydrogen is split into protons, which subsequently traverse the ion exchange membrane and reach the cathode, and electrons which travel to the cathode via the power source. At the cathode protons and electrons form hydrogen gas through the hydrogen evolution reaction.

The electrocatalysts used in electrolyzers may differ from those used in fuel cells. In electrolyzers using PEM electrolytes, the anode-side electrocatalyst often comprises iridium oxide, while the cathode-side electrocatalyst generally comprises platinum or other platinum-group metals. In electrolyzers using an anion exchange membrane, AEM, electrolyte, both electrocatalysts may instead comprise materials such as nickel or cobalt.

In electrolyzers that comprise solid electrolytes such as PEM and AEM the anode and cathode electrocatalysts are often arranged in electrocatalyst layers on opposite sides of the electrolyte membrane to form a membrane electrode assembly, as previously described for fuel cells. One or both electrocatalysts may be in the form of nanoparticles. In addition to the electrocatalyst itself, the electrocatalyst layer may comprise a catalyst support such as carbon black, carbon nanotubes, or a metal foam. The electrocatalyst layer may also comprise an ionically conducting polymer and hydrophobic materials such as Teflon.

The requirements on ion transport through the electrolyte, mass transport of reactants and products to and from the electrocatalyst, and good electrical contact between the elements in the cell are the same in an electrolyzer as in a fuel cell. Therefore, electrolyzers are also often equipped with porous transport layers, PTLs, arranged adjacent to each electrocatalyst layer and conductive elements arranged adjacent to each PTL. The PTLs may comprise porous carbon materials, metal foams, or metal meshes, often comprising titanium. The conductive elements may for example comprise metallic materials such as steel or titanium, or electrically conductive carbon composites.

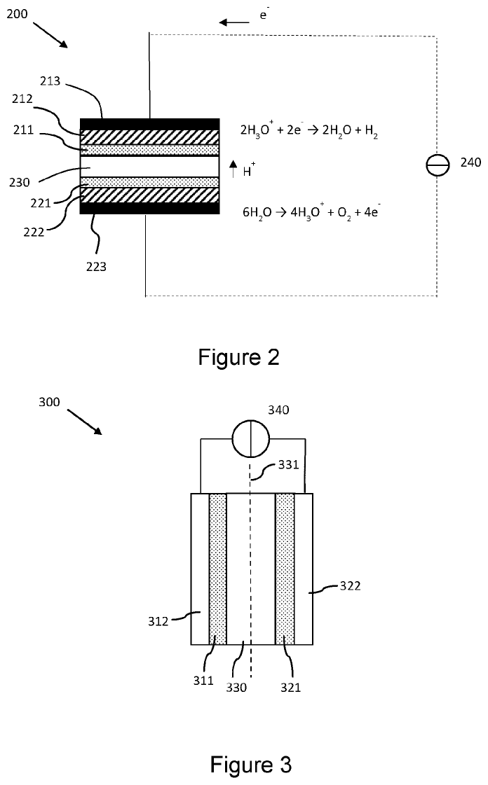

FIG. 2 shows an electrolyzer 200 comprising an ion exchange membrane 230, a first electrocatalyst layer 211 and a second electrocatalyst layer 221. The first and second electrocatalyst layers are arranged adjacent to the ion exchange membrane 230 on either side of the ion exchange membrane. A first PTL 212 and a second PTL 222 are arranged adjacent to the first and second electrocatalyst layer on the side of the electrocatalyst layer facing away from the ion exchange membrane 230. Adjacent to the first and second PTL 212, 222, on the side facing away from the respective electrocatalyst layer, are arranged a respective first and second conductive element 213, 223. Both conductive elements are connected to a power source 240.

In addition to water electrolyzers comprising proton exchange membranes, the present disclosure may also be applied to other types of electrolyzers. For example, the disclosure is applicable to electrolysis of liquids or gases other than water and to electrolyzers wherein another type of electrolyte is used in place of a proton exchange membrane, such as an anion exchange membrane or a liquid electrolyte.

The present disclosure also relates to batteries. Batteries, in general, are used to store chemical energy and release it as electrical current. In particular, rechargeable or secondary battery cells may be used to store electrical energy through repeated charging and discharging of the battery cell. Commonly used rechargeable batteries include various forms of lithium and lithium-ion batteries but may also include e.g. sodium ion batteries.

FIG. 3 shows a battery cell 300 comprising an electrolyte 330, a first electrode 311 and a second electrode 321, shown arranged on either side of the electrolyte 330. The battery cell 300 also comprises a first conductive element 312 and a second conductive element 322, both connected to the electric load 340.

Battery electrolytes may be liquid, semisolids or gels, or solids. Liquid electrolytes typically comprise solutions of an acid, a base and/or a salt in a liquid aqueous or organic solvent, while semisolid/gel electrolytes may comprise a salt and a polymer framework. In lithium-ion or lithium-ion batteries, liquid electrolytes may comprise lithium salts such as LiPF₆, LiAsF₆, LiClO₄, or LiBF₄, and an organic solvent such as ethylene carbonate, diethyl carbonate, or propylene carbonate. Gel electrolytes frequently comprise lithium salts and polymers such as poly (ethylene oxide), poly (acrylonitrile), poly (methyl methacrylate), or poly (vinylidene fluoride). Both liquid and gel electrolytes may necessitate the use of a porous or micro-porous separator membrane 331 arranged intermediate the first and second electrode 311, 321. The porous membrane frequently comprises polyethylene and/or polypropylene.

Note that the term separator is used in two ways in electrochemical cells. The first is to denote the conductive elements used to separate the interior of a fuel cell or electrolyzer from its surroundings, which in this disclosure will be referred to as a separator element, separator plate, or conductive element. The second, as mentioned above, is the membrane used to separate the two halves of a battery cell. In this disclosure, this will be referred to as a separator membrane.

In lithium or lithium-ion batteries, the first electrode 311 or anode may for example comprise metallic lithium, silicon, or a carbon material such as graphite. When the battery is fully charged, lithium is intercalated in the graphite to form LiC6. When the battery is discharged, electrons travel from the anode to the cathode via the electric load, while lithium ions travel from the anode through the electrolyte to the second electrode 321 or cathode. Cathodes in lithium-ion batteries may be oxides of lithium and transition metals such as cobalt, iron or manganese, while cathodes in lithium batteries may e.g. comprise sulfur.

The anode and cathode materials, e.g. graphite and lithium oxides in lithium-ion batteries, are frequently formed into active layers that are deposited on conductive elements also known as current collectors. In addition to the anode and cathode materials, the active layers may comprise conductive additives, as well as polymer binders such as polyvinylidene fluoride or styrene-butadiene copolymers. The conductive additives may for example be carbon allotropes such as carbon nanotubes, carbon black, or carbon nanofibers.

Current collectors in lithium-ion batteries frequently comprise metal sheets of around 10 micrometers thickness. The metals used is selected to withstand the chemical environment of the battery cell. As an example, a current collector may comprise copper or aluminum.

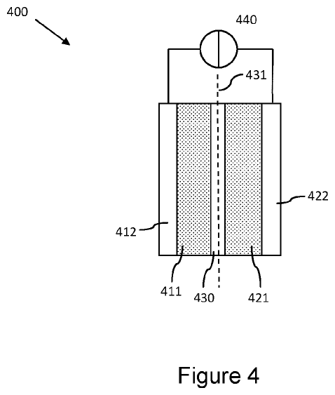

Another example of an electrochemical cell to which the present disclosure is applicable is a supercapacitor. Supercapacitors are energy storage devices using a combination of electrostatic and electrochemical energy storage. FIG. 4 schematically illustrates a supercapacitor 400 comprising a first and second current collector 412, 422. Each current collector is coated with a porous electrode layer 411, 421. Between the two electrode layers there is an electrolyte 430 and optionally a separator membrane 431, and the two current collectors are connected to an electric load 440.

Electrostatic energy storage in the supercapacitor occurs through a double-layer capacitance, where positive and negative ions comprised in the electrolyte form double layers at the surface of each electrode layer. When the capacitor is charged, one electrode acquires a negative charge and the other a positive charge. At the negative electrode, a layer of positive ions will form close to the electrode surface, and a layer of negative ions will form adjacent to the layer of positive ions. At the positive electrode, the layer of ions closest to the surface instead comprises negative ions and the second layer comprises positive ions.

Electrochemical energy storage in the supercapacitor is due to what is known as electrochemical pseudocapacitance. This occurs when, during charging of the supercapacitors, ions comprised in the electrolyte adsorb to the negative electrode and a transfer of electrons occurs from the ions to the electrode. The transferred electrons then traverse the electrical connection between the current collectors and accumulate in the positive electrode.

The first and second current collector 412, 422 comprise electrically conductive materials, often metals such as aluminum, stainless steel, or copper, while the porous electrode layers 411, 421 often comprise carbon allotropes such as activated carbon, graphene, carbon nanotubes, or carbon nanofibers. However, the electrode layers 411, 421 may also comprise e.g. transition metal oxides and/or electrically conductive polymer materials. The electrolyte 430 may be an aqueous solution comprising acid such as sulfuric acid or a base such as potassium hydroxide, or salts such as sodium or lithium perchlorate. The electrolyte could also comprise an organic solvent such as propylene carbonate or diethyl carbonate and salts such as ammonium salts. Finally, the separator membrane 431 may comprise woven glass or ceramic fibers or polymers such as polyacrylonitrile.

It may be noted that supercapacitors comprise components very similar to those of a battery, e.g., current collectors, an electrolyte, and a separator membrane, but with the active layers replaced by porous electrode layers. Due to this similarity, the present disclosure is applicable to supercapacitors in the same ways as to batteries and is associated with the similar advantages in supercapacitors as in batteries.

The different types of electrochemical cells described above, i.e. fuel cells, electrolyzers, batteries, and supercapacitors, contain multiple layers serving different purposes, such as conductive elements, PLTs and active layers or electrocatalyst layers. The same is true for systems such as flow batteries and hybrid supercapacitors. For efficient cell operation, it is important to maintain good mechanical contact between adjacent layers and to minimize electrical contact resistance between e.g. conductive elements and PTLs or PTLs and electrocatalyst layers in fuel cells and electrolyzers, or between current collectors and active layers in batteries. However, it is also important to maintain good mass transport, e.g. through the porous transport layers in fuel cells and electrolyzers. Higher electrical contact resistance sometimes develops as a result of insufficient physical contact, especially since the adjacent layers may have uneven surfaces with protrusions, valleys, and pores that prevent close contact across the entire surface area. The issue may be exacerbated by the formation of compounds that are not electrically conductive, such as metal oxides, on the surfaces.

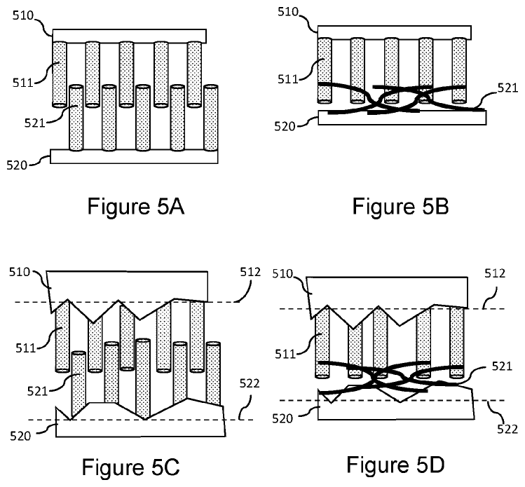

Conversely, if the mechanical contact between adjacent layers can be improved, the electrical contact resistance can be reduced. Accordingly there is herein disclosed, with reference to FIG. 5, an electrochemical cell comprising a layered structure. The layered structure comprises at least a first layer 510 and a second layer 520, where the first layer 510 and the second layer 520 are arranged adjacent to each other and form an interface. The interface comprises a first plurality of elongated nanostructures 511 connected to a first surface of the first layer 510, where the first surface faces the second layer 520. Likewise, a second plurality of elongated nanostructures 521 is connected to a second surface of the second layer 520 that is facing the first layer 510. The first plurality of elongated nanostructures 511 and the second plurality of elongated nanostructures 521 are arranged to be mechanically entangled.

Herein, a layered structure is taken to mean a structure comprising at least two layers. Each layer has two large bounding surfaces that are substantially parallel to each other and typically form the two largest bounding surfaces of the layer. These bounding surfaces can be referred to as the first and second side of the layer. The thickness of the layer in a direction perpendicular to these bounding surfaces is generally much less than the extent of the layer in any direction along the bounding surfaces.

If the layer is a planar element such as a plate or sheet, a plane of extension of the layer can be defined as a plane that is substantially parallel with the two large bounding surfaces. The thickness of the layer may then be defined as the layer size in the direction perpendicular to the plane of extension.

According to some examples, the layers comprised in the layered structure may be curved, in which case the large bounding surfaces are curved surfaces. The layers may e.g. form cylinders or cylindrical shells, if the electrochemical cell is rolled into a cylinder as is the case with some types of batteries. They may also be folded to form a U-shape. In these cases, however, the radius of curvature is typically large enough that the surface is approximately planar on the scale relevant to the elongated nanostructures discussed herein. The plane of extension of the layer can therefore, for the purposes of this disclosure, be approximated with a plane tangential to the curved surface. A person skilled in the art will realize that the present disclosure is applicable also to such rolled or folded electrochemical cells.

The first layer 510 and the second layer 520 are arranged adjacent to each other with the first side of the first layer 510 facing the second side of the second layer 520 and with the planes of extension of the first and second layer 510, 520 substantially parallel. Substantially parallel may in this case be taken to mean that the planes of extension form an angle of less than 20 degrees, and preferably less than 10 degrees.

A nanostructure is a structure having a size that is substantially smaller than one micrometer, and preferably between 1 and 100 nm, in at least one dimension. Herein, an elongated nanostructure is a nanostructure that is substantially larger in at least one dimension, such as length, compared to another dimension such as width.

As an example, consider a substantially cylindrical nanostructure characterized by a length and a diameter. The nanostructure may be considered elongated if the length is significantly larger than the diameter, e.g., if the length is more than twice as large as the diameter. Similar reasoning may be applied to nanostructures that are substantially conical, frustoconical, rectangular, or of arbitrary shape.

The elongated nanostructures may for example be straight, spiraling, branched, wavy or tilted. Optionally, they are classifiable as nanowires, nano-horns, nanotubes, nanowalls, crystalline nanostructures, or amorphous nanostructures.

As another example, consider a substantially planar nanostructure characterized by a width, a length, and a height. The nanostructure may be considered elongated if the width is significantly smaller than the length and/or height, e.g., the width may be less than 50% of the length and/or the height. Optionally, the width may be much smaller than the length or height, such that the width is 1% or less of the length or height. The length and height may in such cases be similar, or the height may be larger than the length. As an example, the height may be twice the length. Such elongated nanostructures may be termed nanoflakes or nanowalls.

The elongated nanostructures comprised in the first and second plurality of elongated nanostructures 511, 521 may be attached to the surface of the respective first and second layer 510, 520 e.g., by a chemical bond, by an adhesive, or by some other attachment means. According to aspects, the first and second plurality of elongated nanostructures may have been grown on the surface of the respective first and second layer 510, 520, in which case they may have a strong chemical bond to the surface. Preferably, the elongated nanostructures should be attached to the surface in a way that leads to low electrical contact resistance between the nanostructures and the surface.

Mechanical entanglement is herein taken to mean that the first and second plurality of elongated nanostructure 511, 521 form an interlocking structure, ensuring that the first and second plurality are in contact over a large fraction of the surface area of the first and/or second plurality of elongated nanostructures 511, 521. A large fraction of the surface area may for example be more than 50% of said surface area.

As previously mentioned, the elongated nanostructures may be larger in one dimension than in other dimensions. Consider an axis along this dimension as the length axis of an elongated nanostructure, and the size of the nanostructure in this dimension as the nanostructure length. The size of the nanostructure in the other dimensions can be referred to as a nanostructure width or, for mostly cylindrical nanostructures, a nanostructure diameter.

The length axis of an elongated nanostructure also indicates the orientation of the nanostructure. For example, an elongated nanostructure can be said to be oriented perpendicular to the first or second layer 510, 520 if the length axis extends perpendicularly or nearly perpendicularly to the plane of extension of the layer, or equally if the length axis is parallel or nearly parallel with the normal vector of the plane of extension. On the other hand, an elongated nanostructure can be said to be oriented in parallel to the first or second layer 510, 520 if the length axis is nearly perpendicular to the normal vector, or nearly parallel to the plane of extension.

If the elongated nanostructure is a nanoflake or a nanowall, an axis along the smallest dimension of the nanostructure, i.e. the width, may be considered as the width axis. The length axis is then an axis perpendicular to the width axis of the nanostructure. Optionally, the length axis may extend along the largest dimension of the nanostructure. In this case, the nanostructure could be said to be oriented perpendicular to the first or second layer 510, 520 if the width axis is parallel to the plane of extension of the layer and/or the length axis is perpendicular to the plane of extension of the layer.

In order to form an interlocking structure, it is advantageous to have at least some of the elongated nanostructures comprised in at least one of the first and second pluralities of elongated nanostructures 511, 521 oriented in parallel to one another along a direction perpendicular to the plane of extension of the respective first or second layer 510, 520.

This should not be taken to mean that the nanostructures are completely straight or completely perpendicular to the plane of extension of the first or second layer 510, 520. The nanostructures may extend generally along a direction perpendicular to the plane of extension. This is taken to mean that the nanostructures can have a moderate tilt relative to the normal vector of the plane of extension, or they may curve back and forth to form a spiraling or wavy shape. That is, the nanostructures extend in the general direction of the normal vector. In this context, a moderate tilt may mean that the angle between the length axis of the elongated nanostructure and the normal vector of the plane of extension is less than 40 degrees, and preferably may be less than 30 degrees.

It may also be advantageous to have at least some of the elongated nanostructures extending at an angle to the normal vector of the plane of extension of the first or second layer 510, 520. The angle between the length axis of an elongated nanostructure and the normal of the plane of extension may for example be in the range of 40 to 60 degrees. Advantageously, the angle may be selected in dependence of e.g. the properties of the first and/or second layer, or on a manufacturing method used to assemble the electrochemical cell.

According to aspects, the length axes of individual nanostructures may have different angles relative to the normal vector, such that not all elongated nanostructures in the first or second plurality of elongated nanostructures 511, 521 are completely parallel to each other. As an example, an angle between the length axes of two elongated nanostructures may be less than 45 degrees, and preferably less than 30 degrees.

As another example, an angle between the length axes of two elongated nanostructures may be equal to or more than 45 degrees.

At least some of the elongated nanostructures comprised in at least one of the first and second plurality of elongated nanostructures 511, 521 may also be oriented along a direction parallel to the plane of extension of the respective first or second layer 510, 520. These elongated nanostructures do not need to be oriented in parallel with each other but may have any orientation parallel or mostly parallel with the plane of extension. The nanostructures may for example extend at an angle of less than 30 degrees, and preferably less than 15 degrees, relative to the plane of extension. Also, the nanostructures are not necessarily completely straight but may for example have a curved, wavy, or spiral shape.

FIGS. 5A, B, C, and D show first and second layers 510, 520 with a first and second plurality of elongated nanostructures 511, 521 attached to a respective first and second surface. FIG. 5A shows the elongated nanostructures comprised in both pluralities of elongated nanostructures extending along a direction perpendicular to the plane of extension of the respective layer. The first and second plurality of elongated nanostructures 511, 521 form an interlocking structure with the elongated nanostructures of the first plurality occupying spaces in-between the elongated nanostructures of the second plurality.

FIG. 5B shows the elongated nanostructures comprised in the first plurality of elongated nanostructures 511 extending along a direction perpendicular to the plane of extension of the first layer 510, while the elongated nanostructures comprised in the second plurality of elongated nanostructures 521 extend along the plane of extension of the second layer 520. Here also the first and second pluralities of elongated nanostructures form an interlocking structure.

The width, length and spacing of the elongated nanostructures comprised in the first and second plurality of elongated nanostructures 511, 521 may be selected to facilitate mechanical entanglement and the formation of an interlocking structure. By spacing is here meant the distance between neighboring elongated nanostructures along the plane of extension of the first or second layer 510, 520.

As an example, both the first and second plurality of elongated nanostructures 511, 521 may comprise nanostructures oriented perpendicular to the plane of extension of the respective first or second layer 510, 520, as shown in FIG. 5A. The formation of an interlocking structure may then be facilitated if the elongated nanostructures comprised in the first and second plurality of elongated nanostructures 511, 521 are of similar width and length with a spacing between the nanostructures in each plurality of elongated nanostructures similar to the width. Similar width, length etc. can be taken to mean that the average width and length of the nanostructures comprised in the second plurality of elongated nanostructures 521 differ from those in the first plurality of elongated nanostructures 511 by 20% or less. The nanostructure length could for example be between 10 and 20 micrometers and the nanostructure width could be around 100 nm in both the first and second plurality of elongated nanostructures 511, 521. The spacing between nanostructures may then be between 100 and 120 nm.

As another example, the first plurality of elongated nanostructures 511 may comprise nanostructures oriented perpendicular to the plane of extension of the first layer 510, while the second plurality of elongated nanostructures may comprise nanostructures oriented in parallel to the plane of extension of the second layer 520, as illustrated in FIG. 5B. The formation of an interlocking structure may then be facilitated if the nanostructures comprised in the first plurality of elongated nanostructures 511 have a length and spacing proportional to the width of the elongated nanostructures comprised in the second plurality of elongated nanostructures 521. The thickness of the elongated nanostructures comprised in the second plurality of elongated nanostructures may for example be around 100 nm, in which case the length of, and spacing between, the elongated nanostructures comprised in the first plurality of elongated nanostructures may be 100 nm or more.

If the second plurality of elongated nanostructures 521 comprises elongated nanostructures that are nearly parallel to the plane of extension of the second layer 520, but still extend at angle relative to the plane of extension, it may be advantageous to consider a maximum distance that the nanostructures extend from the second layer 520. This distance would then be measured along the normal to the plane of extension of the layer. The length of nanostructures in the first plurality of elongated nanostructures 511 oriented perpendicular to the plane of extension of the first layer 510 could then be selected so as to exceed this maximum distance.

It is important to note that the length, width, and spacing of the elongated nanostructures may not be uniform throughout the first or second plurality of nanostructures but may vary from nanostructure to nanostructure depending e.g. on the method of manufacturing the nanostructures. The values given above should therefore be regarded as approximate.

The first and/or second surface forming the first interface may be uneven, e.g. due to the first and/or second layer 510, 520 being porous or the surface comprising bumps, ridges, and/or troughs. In this case, the unevenness may prevent the surfaces being in contact over some part of their surface area, leading to increased electrical contact resistance between the two layers. The first and second plurality of elongated nanostructures 511, 521 may be used to mitigate this problem. For example, it may be advantageous to adjust the length of elongated nanostructures comprised in the first or second plurality of elongated nanostructures 511, 521, especially nanostructures oriented perpendicular to the plane of extension, in order to ensure that all elongated nanostructures from the first plurality of elongated nanostructures 511 are long enough to reach the second plurality of elongated nanostructures 521, and vice versa. Elongated nanostructures on uneven surfaces are illustrated in FIGS. 5C and 5D.

Note that if the surface of the first and/or second layer 510, 520 is uneven, the plane of extension of the layer is not necessarily parallel to every part of the surface. The parallel or perpendicular orientation of elongated nanostructures is defined relative to the plane of extension, not relative to the part of the surface where the nanostructure is attached. In FIGS. 5C and 5D, the plane of extension is indicated by dashed lines 512, 522.

In some cases, either the first or the second layer 510, 520 may comprise a material that changes in volume during operation of the electrochemical cell. As an example, an active layer in a battery may expand as ions enter it during charging or discharging. The length, width and spacing of the elongated nanostructures may advantageously be adjusted to maintain mechanical entanglement and form an interlocking structure both when the first and second layers 510, 520 are maximally expanded and when the layers are maximally contracted. This can e.g. decrease the likelihood that the layers will delaminate during extended operation.

Due to the mechanical entanglement, a close mechanical contact is created between the first and second plurality of elongated nanostructures 511, 521, leading to an improved mechanical contact between the first and second layer 510, 520. The improved mechanical contact will lead to improved electrical contact and reduced contact resistance, particularly if the elongated nanostructures comprise an electrically conductive material. In this case, the mechanical entanglement also establishes an electrical connection with low contact resistance between the first and second plurality of elongated nanostructures 511, 521. This in turn leads to an improved electrical connection between the first and second layers 510, 520.

At least some of the elongated nanostructures comprised in the first plurality of elongated nanostructures 511 may be oriented in parallel to each other and extend along a direction perpendicular to the plane of extension of the first layer 510. Some of the elongated nanostructures comprised in the first plurality of elongated nanostructures 511 may also extend along a direction parallel to the plane of extension of the first layer 510.

Likewise, at least some of the elongated nanostructures comprised in the second plurality of elongated nanostructures 521 may be oriented in parallel to each other and extend along a direction perpendicular to the plane of extension of the second layer 520. Some of the elongated nanostructures comprised in the second plurality of elongated nanostructures 521 may also extend along a direction parallel to the plane of extension of the second layer 520.

Preferably, the elongated nanostructures comprised in the first and/or second plurality of elongated nanostructures 511, 521 comprise an electrically conductive material, that is, a material with an electrical conductivity similar to that of a metal or semiconductor. This has the advantage of improving the electrical connection between the first and second plurality of elongated nanostructures 511, 521.

Accordingly, the first and/or second plurality of elongated nanostructures 511, 521 may comprise nanostructures comprising any of a metal, a metal alloy, a semiconductor, and a metal oxide.

Carbon materials are frequently used in electrochemical cells, e.g., as catalyst support and diffusion layer materials, as well as in the active layers of batteries, due to their good electrical conductivity and chemical stability. In particular, carbon materials are used on both the anode and the cathode side in fuel cells and on the cathode side in electrolyzers. Due to their chemical stability, elongated carbon nanostructures have the advantage that non-conductive compounds are unlikely to form on the surface, which is advantageous for maintaining a low electrical contact resistance. The presence of carbon nanostructures on the surface of the first and/or second layer 510, 520 may also prevent chemical degradation of the layers themselves by shielding the surfaces from the chemical environment of the cell.

The shape and structure of elongated carbon nanostructures can be altered by adjusting the conditions under which the nanostructures are grown, so as to obtain e.g., a desired density or shape of the nanostructures, a desired thickness or length of the nanostructures or a desired number of nanostructures per surface area. Carbon nanofibers and nanowires in particular have the advantage of a high stiffness and rigidity, making them less likely to be deformed if the fuel cell is assembled by a method such as pressing the components together, and more likely to remain in a desired orientation relative to the first and/or second layer 510, 520.

Thus, the first and/or second plurality of elongated nanostructures 511, 521 may comprise elongated carbon nanostructures. The elongated carbon nanostructures may for example comprise carbon allotropes such as any of carbon nanofibers, carbon nanowires, carbon nanotubes, and carbon nanowalls.

According to aspects, the first plurality of elongated nanostructures 511 comprises carbon nanofibers oriented perpendicularly to the plane of extension of the first layer 510, while the second plurality of elongated nanostructures 521 comprises carbon nanotubes oriented parallel to the plane of extension of the second layer 520. According to other aspects, both the first and second plurality of elongated nanostructures 511, 521 comprise carbon nanofibers oriented perpendicular to the plane of extension of the respective first and second layer 510, 520.

The chemical environment in an electrochemical cell can cause corrosion and/or degradation of some materials. Although carbon materials are generally sufficiently chemically stable for use in fuel cells and on the cathode side in electrolyzers, they may require additional surface treatment for use e.g., on the anode side in electrolyzers. Other materials used in electrochemical cells, such as steel, may also require additional treatment in order to tolerate the environment in the electrochemical cell. Thus, the first and/or second plurality of elongated nanostructures 511, 521 may comprise a protective coating arranged to increase a resistance to corrosion. The protective coating may also extend to all or part of the surfaces of the first and/or second layers 510, 520. As an example, the protective coating may comprise any of titanium, gold, platinum, a platinum-group metal, or a combination thereof. As another example, the protective coating may comprise ceramic materials or metal oxides such as aluminum oxide, cerium oxide and zirconium oxide. The protective coating may also comprise carbon-based materials.

According to aspects, the electrochemical cell described above may be a fuel cell 100 comprising a layered structure. The layered structure comprises a first conductive element 113 and a second conductive element 123, as well as a first porous transport layer 112 and a second porous transport layer 122 arranged adjacent to the respective first and second conductive element. The layered structure also comprises a first electrocatalyst layer 111 and a second electrocatalyst layer 121 arranged adjacent to the respective first and second porous transport layer 112, 122, and an ion exchange membrane 130 arranged between the first and second electrocatalyst layer 111, 121.

In such a fuel cell, the first and/or second layer 510, 520 forming the first interface may be any of the first and second conductive elements 113, 123, the first and second porous transport layers 112, 122, or the first and second electrocatalyst layers 111, 121. According to one example, the first layer 510 may be any of the first and second conductive elements 113, 123 and the second layer 520 may be the respective first or second porous transport layer 112, 122. According to another example, the first layer 510 may be any of the first and second porous transport layers 112, 122 and the second layer 520 may be the respective first or second electrocatalyst layer 111, 121.

According to other aspects, the electrochemical cell described above may be an electrolyzer 200 comprising a layered structure. The layered structure comprises a first conductive element 213 and a second conductive element 223 as well as a first porous transport layer 212 and a second porous transport layer 222 arranged adjacent to the respective first and second conductive element 213, 223. The layered structure further comprises a first electrocatalyst layer 211 and a second electrocatalyst layer 221 arranged adjacent to the respective first and second porous transport layer 212, 222, and an ion exchange membrane 230 arranged in-between the first and second electrocatalyst layer 211, 221.

In such an electrolyzer, the first and/or second layer 510, 520 forming the first interface may be any of the first or second conductive element 213, 223, the first or second porous transport layer 212, 222, or the first or second electrocatalyst layer 211, 221. According to one example, the first layer 510 may be any of the first and second conductive elements 213, 223 and the second layer 520 may be the respective first or second porous transport layers 212, 222. According to another example, the first layer 510 may be any of the first and second porous transport layers 212, 222 and the second layer 520 may be the respective first or second electrocatalyst layer 211, 221.

The electrochemical cell described above may also be a battery 300 comprising at least one layered structure, the layered structure comprising a current collector 312, 322 and an active layer 311, 321 arranged adjacent to the current collector 312, 322, where the active layer comprises an electrode material.

Optionally, the layered structure comprised in the battery comprises a first current collector 312 and a second current collector 322, a first active layer 311 and a second active layer 321, and a solid, semisolid or gel-like electrolyte layer 330 arranged in-between the first and second active layers 311, 321. The battery may also comprise two layered structures, each comprising at least one current collector and one active layer, separated by a liquid electrolyte.

As an example, the first layer 510 and the second layer 520 forming the first interface may be respectively the current collector 312, 322 and the active layer 311, 321 in the at least one layered structure.

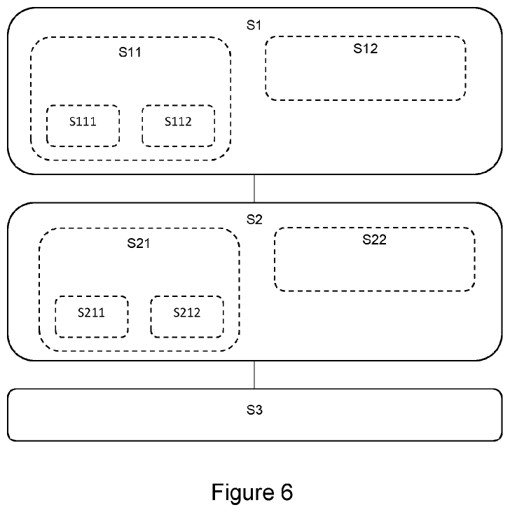

With reference to FIGS. 5 and 6, there is also herein disclosed a method for producing a layered structure for an electrochemical cell. The layered structure comprises at least a first layer 510 and a second layer 520. The method comprises generating S1 a first plurality of elongated nanostructures 511, where the elongated nanostructures are connected to a first surface of the first layer 510. The method also comprises generating S2 a second plurality of elongated nanostructures 521 connected to a second surface of the second layer 520. The method further comprises arranging S3 the first layer 510 adjacent to the second layer 520 to form a first interface, so that the first surface of the first layer 510 faces the second surface of the second layer 520. This enables the first plurality of elongated nanostructures 511 and the second plurality of elongated nanostructures 521 to become mechanically entangled.

A plurality of elongated nanostructures 511, 521 may be generated through lithographic methods such as colloidal lithography or nanosphere lithography, focused ion beam machining and laser machining, among other methods. For nanofibers comprising carbon or organic compounds, methods such as electrospinning or chlorination of carbides such as titanium carbide or metalloorganic compounds such as ferrocene may also be used.

Generating S1, S2 the first and/or second plurality of nanostructures 511, 521 may comprise growing S11, S21 the elongated nanostructures on a substrate. Growing S11, S21 elongated nanostructures 511, 521 on a substrate allows extensive tailoring of the properties of the nanostructures, including the height of the nanostructures, as well as of the spacing between nanostructures. According to aspects, the elongated nanostructures may be grown by plasma-enhanced chemical vapor deposition. The substrate may comprise materials such as silicon, glass, stainless steel, ceramics, silicon carbide, or any other suitable substrate material. The substrate may also comprise polymers such as polymide, which are stable at high temperatures. Optionally, the substrate may be a component for an electrochemical cell, such as a conductive element or a porous transport layer of a fuel cell or electrolyzer, or a current collector for a battery.

Some elongated nanostructures can be grown directly on the substrate. As an example, carbon nanowalls may be grown directly on the substrate at high enough temperatures. High enough temperatures may for example be 700-800° C. The nanowalls may be grown in a plasma.

In other cases, growing S11, S21 the elongated nanostructures on a substrate may comprise depositing S111, S211 a growth catalyst layer on a surface of the substrate and growing the elongated nanostructures on the growth catalyst layer. Herein, a growth catalyst is a substance that is catalytically active and promotes the chemical reactions comprised in the formation of nanostructures.

The growth catalyst may comprise materials such as nickel, iron, platinum, palladium, nickel-silicide, cobalt, molybdenum, gold, or alloys thereof. As an example, the growth catalyst layer may be between 1 and 100 nm thick. As another example, the growth catalyst layer may comprise a plurality of particles of growth catalyst.

Growing S11, S21 the elongated nanostructures 511, 521 on the growth catalyst layer may comprise heating the growth catalyst layer to a temperature where nanostructures can form and providing a gas comprising a reactant in such a way that the reactant comes into contact with the growth catalyst layer. Here, the reactant is a chemical compound or mix of chemical compounds that comprises the chemical elements used to form the nanostructure. For a carbon nanostructure, the reactant may comprise a hydrocarbon such as methane or acetylene, or it may comprise carbon monoxide.

Depositing a growth catalyst layer may comprise depositing S111, S211 a uniform growth catalyst layer and introducing a pattern onto the deposited uniform growth catalyst layer. Introducing a pattern onto the deposited uniform growth catalyst layer could comprise altering the thickness of the growth catalyst layer according to a pattern, or selectively removing the growth catalyst layer in some places. Introducing a pattern onto the growth catalyst layer may for example be accomplished through lithographic methods such as colloidal or nanosphere lithography. The patterning of the growth catalyst layer makes it possible to control the number of nanostructures per surface area on the substrate.

Growing S11, S21 elongated nanostructures on a substrate may comprise depositing S112, S212 an electrically conductive layer on a surface of the substrate. The growth catalyst layer may then be deposited on top of the conductive layer. After growing the elongated nanostructures, parts of the electrically conductive layer that extend between or around the elongated nanostructures may be selectively removed. This removal may for example be accomplished through etching, e.g., plasma etching, pyrolysis etching or electrochemical etching.

The electrically conductive layer electrically grounds the substrate, which is an advantage for certain methods of nanostructure growth such as growth in a plasma.

It may also prevent the diffusion of atoms between the growth catalyst layer and the substrate.

According to aspects, the conductive layer may be between 1 and 100 microns thick.

According to other aspects, the conductive layer may be between 1 and 100 nm thick.

According to aspects, additional layers may be present in addition to the substrate, the growth catalyst layer, and the electrically conductive layer. The materials comprised in the additional layers may be selected to tune properties of the grown nanostructures, facilitate vertically oriented growth, or otherwise improve the result of the growth process. The additional layers may also comprise a component of an electrochemical cell, such as a conductive element, porous transport layer, or current collector.

According to aspects, depositing any layer including the conductive layer and the growth catalyst layer may be carried out by methods such as evaporating, plating, sputtering, molecular beam epitaxy, pulsed laser depositing, chemical vapor deposition, spin-coating, spray-coating, or other suitable methods.

According to aspects, the elongated nanostructures may be grown on a substrate comprising a component for an electrochemical cell. According to other aspects, the elongated nanostructures may be grown on some other substrate and subsequently transferred onto a component for an electrochemical cell.

Optionally, an additional surface treatment or conditioning may be used on the elongated nanostructures after growth. A surface treatment may e.g., aim to improve a resistance to corrosion, improve a wettability of the surface of the nanostructures, decrease a surface resistivity of the nanostructures, or to achieve some other advantageous effect. The surface treatment may comprise the deposition of a substance on the surface of the nanostructures, e.g., through evaporating, plating, sputtering, molecular beam epitaxy, pulsed laser depositing, chemical vapor deposition, spin-coating, spray-coating, or other suitable methods. The surface treatment may also comprise chemical treatments such as etching or functionalization.

The method may also comprise coating S12, S22 the first and/or second plurality of nanostructures 511, 521 with a protective coating arranged to increase a resistance to corrosion. The protective coating may for example comprise materials such as gold, platinum or titanium and may be deposited through evaporating, plating, sputtering, molecular beam epitaxy, pulsed laser depositing, chemical vapor deposition, spin-coating, spray-coating, or other suitable methods.

1. An electrochemical cell comprising a layered structure, the layered structure comprising at least a first layer and a second layer, the first layer and the second layer being arranged adjacent to each other and forming a first interface, wherein the first interface comprises a first plurality of elongated nanostructures connected to a first surface of the first layerfacing the second layer, and a second plurality of elongated nanostructures connected to a second surface of the second layer facing the first layer, the first plurality of elongated nanostructuresand the second plurality of elongated nanostructures being mechanically entangled.

2. The electrochemical cell according to claim 1, wherein at least some of the elongated nanostructures comprised in the first plurality of elongated nanostructuresare oriented in parallel to each other and extend along a direction perpendicular to the plane of extension of the first layer.

3. The electrochemical cell according to claim 1, wherein at least some of the elongated nanostructures comprised in the first plurality of elongated nanostructures extend along a direction parallel to the plane of extension of the first layer.

4. The electrochemical cell according to claim 1, wherein at least some of the elongated nanostructures comprised in the second plurality of elongated nanostructures are oriented in parallel to each other and extend along a direction perpendicular to the plane of extension of the second layer.

5. The electrochemical cell according to claim 1, wherein at least some of the elongated nanostructures comprised in the second plurality of elongated nanostructures extend along a direction parallel to the plane of extension of the second layer.

6. The electrochemical cell according to claim 1, wherein the first and/or second plurality of elongated nanostructures comprises elongated carbon nanostructures.

7. The electrochemical cell according to claim 6, wherein the first and/or second plurality of elongated nanostructures comprises any of carbon nanofibers, carbon nanowires, carbon nanotubes, and carbon nanowalls.

8. The electrochemical cell according to claim 1, wherein the first and/or second plurality of elongated nanostructures comprises nanostructures comprising any of a metal, an alloy, a semiconductor, and a metal oxide.

9. The electrochemical cell according to claim 1, wherein the first and/or second plurality of elongated nanostructures comprises a protective coating arranged to increase a resistance to corrosion.

10. The electrochemical cell according to claim 9, wherein the protective coating comprises any of titanium, gold, platinum, or a platinum-group metal.

11. The electrochemical cell according to claim 1, wherein the electrochemical cell is a fuel cell comprising a layered structure, the layered structure comprising a first conductive element and a second conductive element, the layered structure further comprising a first porous transport layer and a second porous transport layer arranged adjacent to the respective first and second conductive element, a first electrocatalyst layer and a second electrocatalyst layer arranged adjacent to the respective first and second porous transport layer, and an ion exchange membrane arranged in-between the first and second electrocatalyst layer.

12. The electrochemical cell according to claim 11, wherein the first layer is any of the first and second conductive elements and the second layer is the respective first or second porous transport layer.

13. The electrochemical cell according to claim 11, wherein the first layer is any of the first and second porous transport layersand the second layer is the respective first or second electrocatalyst layer.

14. The electrochemical cell according to claim 10, wherein the electrochemical cell is an electrolyzer comprising a layered structure, the layered structure comprising a first conductive element and a second conductive element, the layered structure further comprising a first porous transport layer and a second porous transport layer arranged adjacent to the respective first and second conductive element, a first electrocatalyst layer and a second electrocatalyst arranged adjacent to the respective first and second porous transport layer, and an ion exchange membrane arranged in-between the first and second electrocatalyst layer.

15. The electrochemical cell according to claim 14, wherein the first layer is any of the first and second conductive elements and the second layer is the respective first or second porous transport layer.

16. The electrochemical cell according to claim 14, wherein the first layer is any of the first and second porous transport layers and the second layer is the respective first or second electrocatalyst layer.

17. The electrochemical cell according to claim 1, wherein the electrochemical cell is a battery comprising at least one layered structure, the layered structure comprising a current collector and an active layer , where the active layer comprises an electrode material.

18. The electrochemical cell according to claim 17, wherein the first layer is the current collector, and the second layer is the active layer in the at least one layered structure.

19. A method for producing a layered structure for an electrochemical cell, the layered structure comprising at least a first layer and a second layer, the method comprising:
generating a first plurality of elongated nanostructures, the elongated nanostructures being connected to a first surface of the first layer;
generating a second plurality of elongated nanostructures, the elongated nanostructures being connected to a second surface of the second layer;
arranging the first layer adjacent to the second layer to form a first interface, so that the first surface of the first layer faces the second surface of the second layer, thereby enabling the first plurality of elongated nanostructures and the second plurality of elongated nanostructures to become mechanically entangled.

20. The method according to claim 19, wherein generating the first and/or second plurality of nanostructures comprises growing the elongated nanostructures on a substrate.

21. The method according to claim 20, where growing the elongated nanostructures on a substrate comprises depositing a growth catalyst layer on a surface of the substrate and growing the elongated nanostructures on the growth catalyst layer.

22. The method according to claim 21, where depositing a growth catalyst layer comprises depositing a uniform growth catalyst layer and introducing a pattern onto the deposited uniform growth catalyst layer.

23. The method according to claim 20, comprising depositing an electrically conductive layer on a surface of the substrate.

24. The method according to claim 19, comprising coating the first and/or second plurality of nanostructures with a protective coating arranged to increase a resistance to corrosion.
